(19) United States
(12) Patent Application Publication
(10) Pub. No.: US 2004/0081598 A1
(43) Pub. Date: Apr. 29, 2004

(54) Reactor trapping and oxidation of carbonaceous material

(76) Inventors: Ross Alexander Morgan, Oxfordshire (GB); David Leslie Segal, Oxfordshire (GB); James Timothy Shawcross, Oxfordshire (GB)

Correspondence Address: William H Holt, Law Offices of William H Holt, Unit 2 First Floor, 1423 Powhatan Street, Alexandria, VA, 22314, US

(21) Appl. No.: 10/469,684

(22) PCT Filed: Apr. 19, 2002
(86) PCT No.: PCT/GB02/01820

(30) Foreign Application Priority Data
Apr. 27, 2001 (GB) 0110345.6

(51) Int. Cl. B01J 19/08; B01J 19/12

(52) U.S. Cl. 422/186.04; 422/186.21

(57) ABSTRACT

A reactor (1) comprises a pair of electrodes (4, 13) spaced apart to provide a path therebetween for gas flow. A permeable mass of silicon carbide 816) is provided in the space between the electrodes (4, 13) for trapping carbonaceous material in the gas flowing through the space. The silicon carbide (16) is arranged to have an electrical resistivity which is sufficiently high to permit formation, when an appropriate electrical potential is applied across the electrodes (4, 13), of a plasma in the gas within the interstices of the silicon carbide through which the gas permeates.

The invention relates to a reactor for the trapping and removal of carbonaceous material in a gas stream such as the exhaust of an internal combustion engine.

A number of approaches are currently used for the removal of carbonaceous material and other combustion products from the exhaust of internal combustion engines and diesel engines in particular. The term carbonaceous material refers to carbonaceous particulates commonly referred to as soot, hydrocarbons including polyaromatic hydrocarbons and soluble organic fractions resulting from unregulated combustion products from the exhausts of internal combustion engines. Cordierite ceramic honeycombs that have alternate channels blocked have been evaluated and used for nearly two decades as diesel particulate filters (DPF) and an early discussion of them is given by Wade et al in ‘Diesel Particulate Trap Regeneration Techniques’ published in SAE 810118 (1981). More recently Cutler and Merkel in ‘A New High Temperature Ceramic Material for Diesel Particulate Filter Applications’ in SAE 2000-01-2844, pages 79-87 have reviewed the use of cordierite-based diesel particulate filters. They refer to the geometric properties of a representative filter that is 5.66 inches in diameter, 6 inches in length containing 178 cells per square inch with a wall thickness of 0.012 inches. The ends of alternate cells are blocked off so that exhaust gases pass through the porous walls between the cells and carbonaceous particulate material is trapped within the porous wall structure. Filters with alternate channels blocked off are often referred to as wallflow filters. They can be regenerated by external heating to burn off trapped material or by use of a carbon combustion catalyst such as Eolys, a cerium oxide additive for fuel described in WO 00/43102. Cordierite has a melting point of around 1460° C. and can react with residues of metallic salt additives in lubricating oil and diesel fuel when high temperature excursions are experienced in the exhaust gases to form tightly bonded glass-like deposits on the filter. The low thermal conductivity of cordierite (<2 W m⁻¹ K⁻¹) makes dissipation of heat by the filter material more difficult and can encourage formation of these glass-like deposits. It is difficult to regenerate the filter once the glass is produced and in addition melting and deformation of the cordierite filter can occur at high temperature.

Silicon carbide has traditionally found application as heating elements as highlighted by Moulson and Herbert in ‘Electroceramics: Materials: Properties: Applications’, published by Chapman & Hall, 1993, page 121 who refer to this use that is aided by the low electrical resistivity of this ceramic material. Use of silicon carbide as a substrate for the treatment of vehicle emissions is a recent development and has been restricted to non-plasma aftertreatment processes.

In order to avoid the above problems arising from the use of cordierite DPF, silicon carbide filters of a similar geometry to conventional diesel particulate filters have been used as discussed by Ohno et al in ‘Characterization of SiC-DPF for Passenger Car’ in SAE 2000-01-0185 pages 25-38. Silicon carbide can operate at temperatures higher than cordierite as its sublimation temperature 2200° C. is much higher than the melting point of cordierite, 1460° C. Silicon carbide has a higher thermal conductivity than cordierite, 73 W m⁻¹ K⁻¹ compared to 2 W m⁻¹ K⁻¹ according to Ohno et al. These properties together with the lower chemical reactivity of silicon carbide towards additives in the lubricating oil and diesel fuel considerably reduce the tendency to form glass-like deposits on silicon carbide filters. Silicon carbide filters can be regenerated by the same methods used for regeneration of cordierite filters. Morawietz in ‘Not Just Clean, but Pure’ in Automotive Business International January/February 2001, pages 68-70 describes the use of a silicon carbide filter in combination with a cerium-based carbon combustion catalyst.

Silicon carbide fibre has also been used for construction of diesel particulate filters for removing carbonaceous particulate material. EP 0 742 352 B (Isuzu) describes a diesel particulate filter consisting of long silicon carbide fibre that can be in the form of a felt. The filter is regenerated by electrically heating a conducting metallic net that heats up the fibre and b urns off particulate material. The electrical resistivity of silicon carbide has not been referred to in the above examples as an important parameter for regeneration of the diesel particulate filter. Continuous silicon carbide fibre, in contrast to whiskers or chopped fibre can be prepared by a process known as polymer pyrolysis from polymers known as polycarbosilanes as described by Riedel in ‘Advanced Ceramics from Inorganic Polymers’, in Processing of Ceramics, edited by R J Brook, VCH Publishers, (1996), pages 1-50. The pyrolysis of polycarbosilanes has led to the commercial production of continuous silicon carbide fibre known as Nicalon™ (Nippon Carbon) and Tyranno™ (Ube Industries). It is possible to obtain continuous silicon carbide fibre with a range of electrical resistivities. For example, high volume resistivity grade Nicalon™ has a volume resistivity of 10⁶ ohm cm while low volume resistivity grade Nicalon™ has a resistivity of 0.5-5.0 ohm cm as described in the Technical Leaflet: Nicalon™ Fiber published by Nippon Carbon Company Limited (1998). The technical leaflet Polycarbosilane ‘Nipusio®’ published by Nippon Carbon Company (1995) indicates that the atmosphere in which polymer pyrolysis takes place, oxidising or inert, can affect the electrical resistivity of the resulting silicon carbide fibre.

None of the above uses of silicon carbide for the treatment of vehicle exhaust emissions involve the use of non-thermal plasmas. There is increasing interest in the use of non-thermal plasmas for treatment of gaseous exhausts, in particular for treatment of exhausts from motor vehicles. Examples of non-thermal plasma treatment of exhausts are described in U.S. Pat. No. 3,983,021 (Monsanto), U.S. Pat. No. 5,147,516 (Tecogen) and U.S. Pat. No. 5,254,231 (Battelle Memorial Institute). GB 2,274,412 (AEA Technology) describes a method for the treatment of diesel emissions by a non-thermal plasma for oxidation of carbonaceous particulates and reduction of NOₓ to nitrogen. Plasma can be used to activate or produce reactant species, which then subsequently react with or without catalytic enhancement to yield the desirable products. For example, WO99/12638 describes the plasma production of plasma activated hydrocarbons as a precursor to the selective catalytic reduction of NOₓ to N₂. Other examples of plasma and plasma-catalyst systems for treatment of exhaust gases are described in WO 00/29727 (Engelhard), U.S. Pat. No. 6,038,854 (Regents of the University of California) and WO 00/21646 (Johnson Matthey).

There is a requirement for a material for treatment of carbonaceous particulate in exhaust gases, particularly in diesel exhaust gases from vehicles, which avoids the disadvantages of cordierite and that can be used in a non-thermal plasma. The low electrical resistivity of silicon carbide renders it unsuitable for use as a trap for carbonaceous matter in a plasma reactor because the low electrical resistivity prevents establishment of the required electric field across the trap for generation of the plasma.

It is an object of the invention to provide a reactor incorporating a trapping material for carbonaceous matter which avoids the disadvantages of cordierite and is also suitable for use in a non-thermal plasma.

The invention is not restricted to a particular type of non-thermal reactor and may be put into practice in dielectric barrier reactors also known as silent discharge reactors, packed bed reactor also known as pellet bed reactor, pulsed corona reactor, microwave reactor or surface discharge reactor.

The invention provides a reactor for the trapping and oxidation of carbonaceous material in a gas stream, such as the exhaust from an internal combustion engines which reactor comprises a pair of electrodes spaced apart and adapted on application of a suitable electrical potential thereacross for generating a plasma in gas flowing through the space between the electrodes, characterised in that a gas permeable mass of silicon carbide is provided in the space between the electrodes for trapping carbonaceous material thereon, and in that provision is made for the mass of silicon carbide to have an electrical resistivity which is sufficiently high to permit formation of a plasma in gas within the interstices of the silicon carbide through which the gas permeates.

Preferably the reactor is a dielectric barrier reactor, there being provided a continuous dielectric layer between the said pair of electrodes.

Also, in operation of a reactor according to this invention, the trapped material can be activated by the plasma or trapping material to a state where it can react with for example NOₓ to yield desirable products. The permeable mass of silicon carbide, or a coating or constituent thereof, or the trapped species itself may, in the presence of a plasma act as a catalytic surface but importantly neither the plasma nor the permeable mass nor the trapped species alone need necessarily have intrinsic catalytic properties. One example of a trapped species is carbonaceous particulate material from a diesel engine, for example soot that consists mainly of elemental carbon. In the plasma region soot becomes exposed to plasma generated species for example oxygen atoms. Oxygen atoms or other plasma generated species may diffuse into, adsorb and react with soot. Other plasma generated species include but are not restricted to OH, O₃ and NO₂. For example it is known oxygen atoms can diffuse into soot and form aldehyde-type groups on the surface. Oxygenated soot has different activated and catalytic properties to non-oxygenated soot.

The gas permeable mass of silicon carbide may be provided in the form of a monolith, wall flow honeycomb filter, foam, graded foam, plates, fibres, meshes or weaves or combinations of these shapes. Fibres can be in the form of continuous or chopped fibre, felt, mat or blanket where the fibres can be randomnly or non-randomnly oriented. The required high electrical resistivity of the silicon carbide is preferably provided by doping of the silicon carbide during manufacture or by a heat treatment of the silicon carbide in a controlled gaseous atmosphere, the doping and heat treatment being of an extent to allow the establishment of an electric field and plasma across the material. For example a silicon carbide identified as SC-211 (http://www.kyocera.com) is commercially available from Kyocera which has a volume electrical resistivity of 8×10¹⁴ ohm cm at ambient temperature. This grade of silicon carbide can be fabricated as a powder and the powder formed into a number of shapes such as plates, discs and cylinders.

Our investigations have indicated that a volume electrical resistivity of 10⁶ ohm cm at ambient temperature or greater is required if non-thermal plasma is to be satisfactorily established within the interstices of the silicon carbide through which the gas permeates. Preferably the volume electrical resistivity is significantly greater than 10⁶ ohm cm.

For silicon carbide in the form of fibres, it is possible for the required high electrical resistivity to be provided by the gaseous atmosphere used when polymer pyrolysis is carried out during manufacture. High volume resistivity grade Nicalon™ has a volume resistivity of 10⁶ ohm cm and can be used. This value of resistivity is the maximum available commercially for the fibre. However a post manufacturing treatment may be used to alter the electrical resistivity of silicon carbide fibres. For example an adherent ceramic coating can be deposited onto the fibres by a gas phase reaction for example by chemical vapour deposition. Silica coatings may be suitable for this purpose.

Specific constructions of reactor embodying the invention will now be described by way of example and with reference to the drawings filed herewith in which:

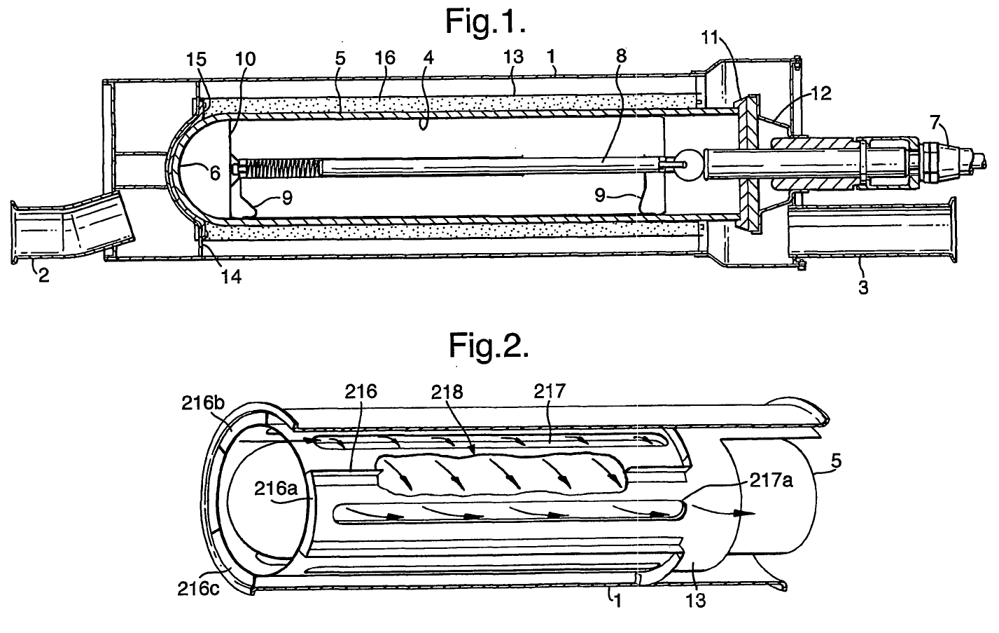

FIG. 1 is a longitudinal section of a reactor embodying the invention for the removal of carbonaceous combustion products and other combustion products from the exhaust emissions of internal combustion engines and

FIG. 2 is a schematic view showing the gas path through the embodiment shown in FIG. 1. Both FIG. 1 and FIG. 2 are described in application WO 00/71866.

Referring to FIG. 1 a reactor for the plasma assisted processing of the exhaust emissions from internal combustion engines to remove noxious components therefrom consists of a reactor chamber 1 which has inlet and outlet stubs 2, 3, respectively by means of which it can be incorporated into the exhaust system of an internal combustion engine.

Inside the reactor chamber 1 there is a an inner electrode 4 which is supported within a dielectric tube 5 made for example out of α-alumina which has its upstream end closed by a spherical dome 6 to facilitate the flow of exhaust gases through the reactor. The inner surface of the dielectric tube 5 can be metallised with a metal coating in order to increase the physical contact between the electrode and dielectric tube although in this example, the inner electrode 4 is conveniently provided the inner surface of the dielectric tube 5. High voltage connection via a high voltage input terminal 7 is made through a spring loaded telescopic tube assembly 8 and spring contacts 9. Load from the sprung telescopic tube assembly 8 is received by a load spreader plate 10, which is connected to the conducting layer of silver forming the inner electrode 4. The materials including the spring are required to operate at elevated temperatures and the spring must have low creep at such temperatures. A preferred material for the spring is an Inconel alloy such as X750. Alumina end flange 11 is shaped to receive and locate the end of the dielectric tube 5 and is itself located by a sprung metal clip 12. The space between the dielectric tube 5, on the inner surface of which is the inner electrode 4, and the outer elcetrode 13 is filled with a gas permeable mass of silicon carbide illustrated diagrammatically at 16. This mass of silicon carbide may be in the form of a foam, grade foam, wallflow honeycomb filter, plates, porous particles, fibres, meshes, weaves or a self-supporting hollow cylinder constructed of silicon carbide with a fine pore structure so that it is gas permeable or combinations of these shapes.

A potential of the order of kilovolts to tens of kilovolts and repetition frequencies in the range 50 to 5000 Hz can be applied to the inner electrode 4 through the high voltage input terminal 7. Pulsed direct current is convenient for automotive use but alternating potentials for example triangular or sine waves or square wave or saw tooth wave of the same or similar characteristics can be used separately or in combination. Concentric with the inner electrode 4 and dielectric tube 5 is a grounded outer electrode 13 made for example of stainless steel. At the inlet end of the reactor the spherical dome of the dielectric tube 5 is in contact with a compliant heat resistant material 14 that rests in the curved part of the outer electrode 13 and held in place by a metallic ring 15 with a series of screws.

As shown in FIG. 2, the outer electrode 13 has a series of baffles 216 and slots 217,217a. The baffles 216 extend from the outer electrode 213 to the inner surface of the wall of the reactor chamber 21 and act as grounding connections as well as causing the exhaust gases to follow a convoluted path which has both axial, and circumferential components and being at least partially helical. There is also a radial component of flow, initially inwardly as the gas transfers from outside the outer electrode 213 to the space between the dielectric tube 5 and the outer electrode 13 and then outwardly as the gas returns to exit from outside the outer electrode 13. Thus there is also a spiral component in the flow.

The baffle 216 is arranged to divide the space between the electrode 13 and the reactor chamber 1 into six segments. At the gas inlet end three of these segments are closed off at 216a, 216b and 216c to axial gas flow and the remaining three segments are open to axial gas flow into the space between the electrode 13 and the reactor chamber 1. These latter three segments are closed off by the baffle 216 at the gas outlet end of the reactor. Consequently the gas is forced to pass via slot 217 radially into the space between the electrodes 13 and 4 then passing in at least a partially helical manner before passing radially via the next slot 217a into the next segment of space between-electrode 13 and reactor chamber 1. The baffle 216 leaves open this segment at the gas outlet end, allowing exhaust of the treated gas to exit the reactor. Thus it will be seen that the exhaust gases both enter and leave the main part of the reactor 1 along the surface of the outer electrode 13. Thus for a given gas velocity, the residence time of the exhaust gases in the electric field is increased compared with either purely axial or radial flow. Note that in FIG. 2 part of the electrode 13 has been shown cut away at 218. This cut away is shown in FIG. 2 only to illustrate the flow of the exhaust gases as they pass between the electrodes and does not represent a structural feature of the reactor.

In operation, the exhaust gas is caused to permeate through the mass of silicon carbide 16, In so doing, carbonaceous particulates and other carbonaceous matter become trapped on the silicon carbide. Non-thermal plasma, sustained in the gas in the interstices of the gas permeable mass of silicon carbide 16, by the applied electrical potential, is effective both directly and via active species produced in the plasma to oxidise the trapped carbonaceous matter.

When the silicon carbide 16 is in the form of a wallflow honeycomb it can consist of an array of channels, typically 200 per square inch with alternate channels blocked off at their ends, extending along the length of the honeycomb parallel with the axis of the honeycomb although other forms of silicon carbide can be used or a packing of silicon carbide fibres or porous particles. For example a foam or other suitable monolithic form can be used or a packing of silicon carbide fibres or porous particles. If a foam is used a sintering aid to aid diffusion or encourage liquid-phase sintering during manufacture, for example aluminium oxide, may be present in the silicon carbide as silicon carbide by itself is particularly difficult to shape by sintering because of the essentially covalent nature of this material. Reaction bonded silicon carbide shapes can also be used and can be produced by infiltration of molten silicon into a ceramic body shaped out of α-silicon carbide powder and a carbon source, a powder or phenolic resin as examples. Such shapes do not exhibit significant dimensional changes on reaction with molten silicon. Excess porosity in the reaction bonded silicon carbide is filled with silicon during the reaction bonding process. An example of reaction bonded silicon carbide is REPEL™ (British Nuclear Fuels).

In all cases, however, it is important that the silicon carbide has high electrical resistivity, as explained so that non-thermal plasma can be produced in gas within the interstices of the silicon carbide by application of the electrical potential. This can be provided inherently in the silicon carbide itself by adopting material commercially available as SC-211 from Kyocera or commercially available fibres with a suitable electrical resistivity. Our investigations have indicated that the volume electrical resistivity should be at least 10⁶ ohm cm and preferably significantly higher. If fibres are used, electrical resistivity can be provided by a suitable coating applied to the fibres subsequently to their manufacture. In this case silicon carbide fibres available from Nippon Carbon as Nicalon™ or from Ube Industries as Tyranno™ can be used. Both of these are derived from polycarbosilane precursors, while Tyranno also incorporates titanium or zirconium into the fibre structure.

Operation of the reactor can be further enhanced by provision of a catalytic coating on the silicon carbide. Such a catalytic coating may enhance the oxidation process of trapped carbonaceous matter and/or catalyse other desired reactions on other noxious constituents of the permeating gas such as the catalytic removal of nitrogeneous oxides. Suitable catalytic materials are described in WO 99/12638, WO 00/43102, WO 99/38603 and 00 15952.5 (UK filed 30 Jun. 2000).

The invention is not restricted to the details of the foregoing examples. For instance, other configurations of reactor can be used, although the particular form in which the mass of gas permeable silicon carbide is provided has to be selected According to the nature of the gas flow path provided. Subject to this, examples of other reactor configurations which may be used are described in patent publications WO 00/71866, WO 99/47243, WO 99/67510 or WO 99/12638 as well as other types of non-thermal plasma reactors such as pulsed corona reactors and surface discharge reactors. When alternating potentials are used triangular waves, sine waves, square waves or saw-tooth waves can be used separately or in combination as can pulsed direct current for other reactor configurations.

1. A reactor for the trapping and oxidation of carbonaceous material in a gas stream, which reactor comprises a pair of electrodes (4, 13) spaced apart and adapted on application of a suitable electrical potential thereacross for generating a plasma in gas flowing through the space between the electrodes (4, 13), characterised in that a gas permeable mass of silicon carbide (16) is provided in the space between the electrodes for trapping carbonaceous material thereon, and in that provision is made for the mass of silicon carbide (16) to have an electrical resistivity which is sufficiently high to permit formation of a plasma in gas within the interstices of the silicon carbide (16) through which the gas permeates.

2. A reactor as claimed in claim 1, in which there is provided a continuous dielectric layer (5) between the said pair of electrodes (4,13), whereby the reactor is a dielectric barrier reactor.

3. A reactor as claimed in claim 1 or claim 2, in which the gas permeable mass of silicon carbide (16) is provided in the form of a monolith, honeycomb, wall flow filter, foam, plates or fibres.

4. A reactor as claimed in claim 3, further characterised in that the gas permeable mass of silicon carbide (16) is in the form of fibres and the high electrical resistivity is provided by a coating on the fibres.

5. A reactor as claimed in claim 3, further characterised in that the gas permeable mass of silicon carbide (16) is so made as to possess in bulk the said sufficiently high electrical resistivity.

6. A reactor as claimed in claim 5, further characterised in that the volume electrical resistivity of the gas permeable mass of silicon carbide (16) is at least 10⁶ ohm cm.

7. A reactor as claimed in claim 6, further characterised in that the gas permeable mass of silicon carbide (16) is fabricated from that designated as SC-211 from Kyocera having a volume electrical resistivity of 8×10¹⁴ ohm cm.

8. A reactor as claimed in any of the preceding claims, in which exposed surfaces of the gas permeable mass of silicon carbide are coated with a catalytic
